(19) United States
(12) Patent Application Publication
(10) Pub. No.: US 2026/0211114 A1
(43) Pub. Date: Jul. 23, 2026

(54) COMPUTER SYSTEM, METHOD AND PROGRAM

(71) Applicant: Sony Interactive Entertainment Inc., Tokyo (JP)

(72) Inventor: Hideaki Iwaki, Kanagawa (JP)

(73) Assignee: Sony Interactive Entertainment Inc., Tokyo (JP)

(21) Appl. No.: 19/572,165

(22) Filed: Mar. 19, 2026

Related U.S. Application Data
(63) Continuation of application No. PCT/JP2023/034809, filed on Sep. 26, 2023.

(51) Int. Cl. G01S 17/86; G01S 7/4865; G01S 17/10; G06T 7/246; G06T 7/73

(52) U.S. Cl. CPC G01S 17/86; G01S 7/4865; G01S 17/10; G06T 7/248; G06T 7/74

(57) ABSTRACT

A computer system is provided, the computer system executing an operation which includes: fusing first frame data generated at a first interval, with second frame data which includes a plurality of sub-frame data generated at an interval shorter than the above first interval, the second frame data being generated at a second interval longer than the above first interval as a whole; selecting, based on a reference time of the above first frame data, at least two of the above sub-frame data included in the above second frame data which are respectively different; and generating the above second frame data from the above selected sub-frame data, wherein the above fusing includes fusing the above second frame data generated from the above selected sub frame data with the above first frame data.

### CROSS-REFERENCE TO RELATED APPLICATIONS

This application is a Continuation application under 35 U.S.C. § 111 of International Patent Application No. PCT/JP2023/034809, filed on Sep. 26, 2023, the entire disclosure of which is incorporated herein by reference for all purposes.

### TECHNICAL FIELD

The present disclosure relates to a computer system, method, and program.

### BACKGROUND

A Time of Flight (ToF) sensor for measuring a distance based on a flight time of light is used for, for example, acquiring three-dimensional information of a subject to be photographed. The ToF sensor is classified roughly into a direct ToF (dToF) method for measuring a time difference until reflection light is sensed, and an indirect ToF (iToF) method for accumulating the reflection light and detecting a phase difference between the reflection light and emission light to thereby measure the distance. The technique of using the ToF sensor by combining it with a camera is described in, for example, JP 2022-101310A describing a technique for carrying out coordinate calibration more easily and automatically in a distance measurement system for generating a distance image of an object by installing a distance measurement sensor and an imaging camera.

### SUMMARY

As in the above-described example, the ToF sensor and the camera are used in combination, so that, for example, coloring can be performed from an RGB image on a point cloud obtained in accordance with the distance measurement by the ToF sensor, a distance measurement point with a low space resolution can be up-sampled based on the RGB image, or the RGB image and the distance measurement point can be fused (Fusion) by means of a SLAM, etc. However, frame intervals of the ToF sensor and the camera are different and therefore the image and the measurement result cannot be properly associated with each other in certain cases.

Therefore, the object of the present disclosure is to provide a computer system, method, and program which can associate a frame generated by each sensor more properly, even if the frame intervals of sensors (including cameras) sensing a space are different.

According to a certain viewpoint of the present disclosure, a computer system is provided, the computer system including a memory for storing a program code and a processor for executing an operation in accordance with the above program code, wherein the above operation includes: fusing first frame data generated at a first interval by a first sensor sensing a space, with second frame data including a plurality of sub-frame data generated at an interval shorter than the above first interval by a second sensor sensing the above space, the second frame data being generated at a second interval longer than the above first interval as a whole; selecting, based on a reference time of the above first frame data, at least two of the above sub-frame data included in the above second frame data which are respectively different; and generating the above second frame data from the above selected sub-frame data, wherein the above fusing includes fusing the above second frame data generated from the above selected sub-frame data with the above first frame data.

According to another viewpoint of the present disclosure, a method is provided, the method including, by an operation executed by a processor in accordance with a program code stored in a memory: fusing first frame data generated at a first interval by a first sensor sensing a space, with second frame data including a plurality of sub-frame data generated at an interval shorter than the above first interval by a second sensor sensing the above space, the second frame data being generated at a second interval longer than the above first interval as a whole; selecting, based on a reference time of the above first frame data, at least two of the above sub-frame data included in the above second frame data which are respectively different; and generating the above second frame data from the above selected sub-frame data, wherein the above fusing includes fusing the above second frame data generated from the above selected sub-frame data with the above first frame data.

According to a further viewpoint of the present disclosure, a program is provided, wherein an operation executed by a processor in accordance with the above program includes: fusing first frame data generated at a first interval by a first sensor sensing a space, with second frame data including a plurality of sub-frame data generated at an interval shorter than the above first interval by a second sensor sensing the above space, the second frame data being generated at a second interval longer than the above first interval as a whole; selecting, based on a reference time of the above first frame data, at least two of the above sub-frame data included in the above second frame data which are respectively different; and generating the above second frame data from the above selected sub-frame data, wherein the above fusing includes fusing the above second frame data generated from the above selected sub-frame data with the above first frame data.

### BRIEF DESCRIPTION OF DRAWINGS

FIG. 1 is a drawing showing an example of a system according to the present disclosure.

FIG. 2 is a timing chart showing an example of an exposure timing of a camera and a sensor in the system shown in FIG. 1.

FIG. 3 is a drawing for conceptually explaining a problem which may occur in the example in FIG. 2.

FIG. 4 is a flow chart showing an example of a process according to an embodiment of the present disclosure.

FIG. 5 is a drawing for conceptually explaining the process in FIG. 4.

FIG. 6 is a drawing for conceptually explaining the process in FIG. 4.

FIG. 7 is a flow chart showing an example of a process according to an embodiment of the present disclosure.

FIG. 8 is a drawing for conceptually explaining the process in FIG. 7.

FIG. 9 is a drawing for conceptually explaining the process in FIG. 7.

FIG. 10 is a flow chart showing an example of a process according to an embodiment of the present disclosure.

FIG. 11 is a drawing for conceptually explaining the process in FIG. 10.

FIG. 12 is a drawing for conceptually explaining the process in FIG. 10.

### DETAILED DESCRIPTION

Hereinafter, some embodiments of the present disclosure will be explained in detail with reference to the attached drawings. In the present specification and the drawings, the components having substantially the same functional configurations have the same reference numerals appended thereto and thus repeated explanation thereof is omitted.

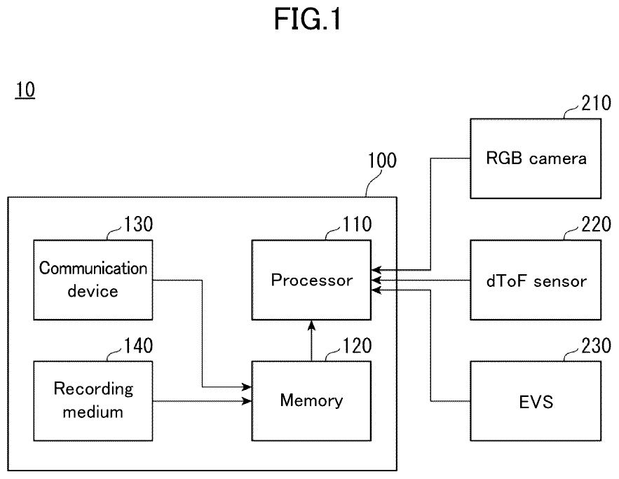

FIG. 1 is a diagram showing an example of a system according to an embodiment of the present disclosure. In the illustrated example, a system 10 includes a computer 100, an RGB camera 210, a direct Time of Flight (dToF) sensor 220, and an event-based vision sensor (EVS) 230. The RGB camera 210 and the EVS 230 are arranged so that the position relationship with respect to the dToF sensor 220 is as already known, and it is possible to associate an image taken by the RGB camera 210 and event information acquired by the EVS 230 with a distance measurement result by the dToF sensor 220.

The computer 100 is, for example, a game machine, a personal computer (PC), or a server device connected to the network. The computer 100 includes a processor 110 and a memory 120. The processor 110 is configured from a processing circuit such as, for example, a Central Processing Unit (CPU), a Digital Signal Processor (DSP), an Application Specific Integrated Circuit (ASIC), and/or a Field-Programmable Gate Array (FPGA). Further, the memory 120 is configured from a storage device such as, for example, various kinds of Read Only Memories (ROMs), Random Access Memories (RAMs), and/or Hard Disk Drives (HDDs). The processor 110 operates in accordance with a program code stored in the memory 120. The computer 100 further includes a communication device 130 and a recording medium 140. For example, the program code allowing the processor 110 to operate in a manner as explained below may be received from an external device via the communication device 130, and stored in the memory 120. Alternatively, the program code may be loaded from the recording medium 140 into the memory 120. The recording medium 140 includes a removable recording medium such as, for example, a semiconductor memory, a magnetic disk, an optical disk, or a magneto-optical disk, and a driver therefor.

The RGB camera 210 includes an imaging element and acquires an RGB image. The dToF sensor 220 includes a light source for laser light and a light reception element arranged for every pixel. The dToF sensor 220 moreover outputs, for every pixel, a result of measuring a time difference until the laser light radiated from the light source is received as reflected light. The EVS 230 is also referred to as an Event Driven Sensor (EDS), an event camera, or a Dynamic Vision Sensor (DVS), and includes a sensor array configured from sensors including the light reception element. As for the EVS 230, when the sensor detects an intensity change of incident light, more specifically, a luminance change of an object surface, the EVS 230 generates an event signal including a time stamp, identification information of the sensor, and information on a polarity of the luminance change. As for an embodiment of the present disclosure explained below, the RGB camera 210 and the dToF sensor 220 are examples of the sensors which sense the space to generate frame data. The frame data are data including the sensing result generated by the sensor in a predetermined period, and is also referred to simply as a frame, in the explanation below. The image data generated by the RGB camera 210 and data of a distance at every distance measurement point generated by the dToF sensor 220 are examples of the frame data.

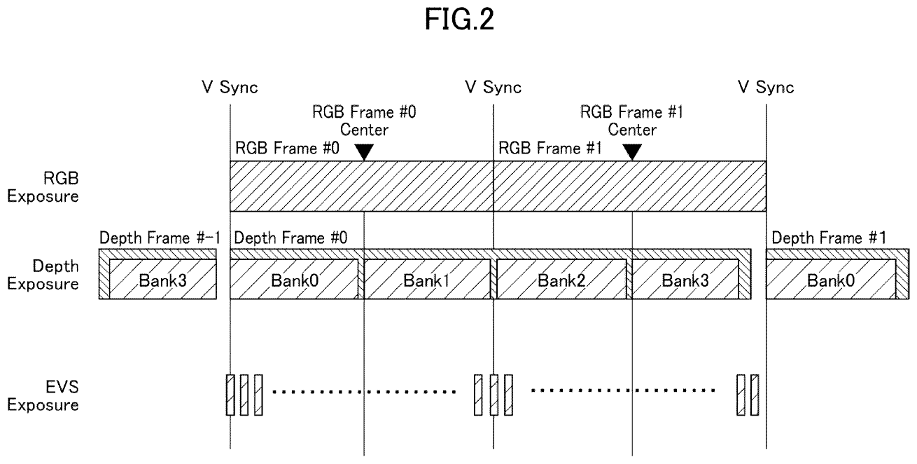

FIG. 2 is a timing chart showing an example of an exposure timing of the camera and the sensor in the system shown in FIG. 1. Though the EVS 230 is not exposed in a frame unit, the exposure of the EVS 230 is additionally illustrated in the diagram of the exposure timing for the sake of convenience of explanation. The RGB camera 210 (RGB Exposure) performs exposure for every vertical synchronization (V Sync) to generate an image. In FIG. 2, the two successive RGB frames (RGB Frame #0 and RGB Frame #1) are shown. Meanwhile, the dToF sensor 220 (Depth Exposure) does not execute the distance measurement at all the distance measurement points at the same time, but classifies the distance measurement points into groups which are also referred to as Banks, thereby successively executing the distance measurement by emission and reception of the laser light. In the illustrated example, the distance measurement points are classified into four Banks (Bank0, Bank1, Bank2, and Bank3), and the time for executing the distance measurement one at a time for each of these Banks is illustrated as the frames of the dToF sensor 220 (a part of Depth Frame #-1, Depth Frame #0, and a part of Depth Frame #1). In this example, the data of the distance at every distance measurement point of each Bank are a plurality of sub-frame data constituting the frame data generated by the dToF sensor 220. The EVS 230 (EVS Exposure) generates an event signal for the intensity change of the light in a time asynchronous manner, and the time resolution is higher than those in the RGB camera 210 and the dToF sensor 220. Namely, an interval in which the EVS 230 generates the event signal by the intensity change of the light due to, for example, movement of an object is shorter than the exposure times of the RGB camera 210 and the dToF sensor 220.

In the above example, the exposure time for one frame of the dToF sensor 220 is longer than the exposure time for one frame of the RGB camera 210 and is approximate to the exposure time for two frames. Namely, the Depth frame generated by the dToF sensor 220 is generated as a whole at an interval longer than an interval in which the RGB frame is generated by the RGB camera 210. Meanwhile, the individual Banks (sub-frame data) included in the Depth frame are generated at an interval shorter than the interval in which the RGB frame is generated.

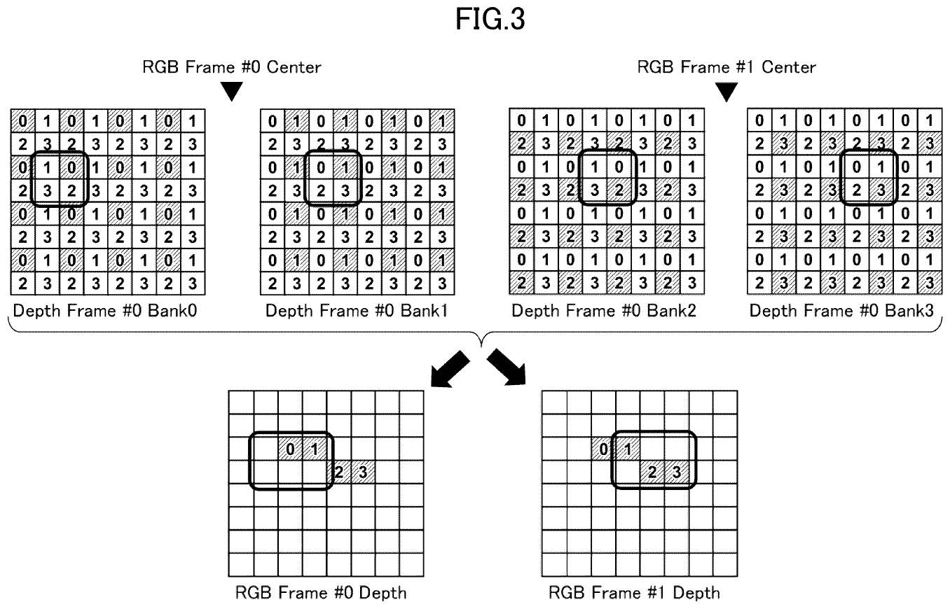

FIG. 3 is a diagram for conceptually explaining a problem which may occur in the example in FIG. 2. As already explained, in Depth Frame #0, the distance measurement is successively executed at the respective distance measurement points in Bank0, Bank1, Bank2, and Bank3. As shown in the timing chart of FIG. 2, both RGB Frame #0 and RGB Frame #1 are included in Depth Frame #0. The center time (Center) of the exposure of RGB Frame #0 is located between the exposure times of Bank0 and Bank1 in Depth Frame #0, and the center time (Center) of the exposure of RGB Frame #1 is located between the exposure times of Bank2 and Bank3 in Depth Frame #0. The center times in entire Depth Frame #0 are approximately between the exposure times of Bank #1 and Bank #2. Therefore, the center times in the two RGB frames deviate from the center times in the Depth frames in both cases.

In the case where the distance measurement result of a Depth frame was fused (Fusion) with the image in the RGB frame in the state where the exposure time centers deviate from each other as described above, an area in the RGB frame where a subject to be photographed exists comes to greatly deviate from an area in the Depth frame where a depth position of the same subject to be photographed is detected, so that the image is not properly associated with the distance measurement result in certain cases. Specifically, in RGB Frame #0 Depth with which the depth position of Depth Frame #0 is associated, the area where the depth of the subject to be photographed is detected deviates substantially rightward, with respect to the area where the subject to be photographed exists during the exposure time (shown by the area being surrounded by the frame; due to motion blur, this area is larger than the area of the subject to be photographed similarly shown in each Bank of the Depth frame). Similarly, in RGB Frame #1 Depth as well, with which the depth position of Depth Frame #0 is associated, the area where the depth of the subject to be photographed is detected deviates leftward with respect to the area where the subject to be photographed exists during the exposure time.

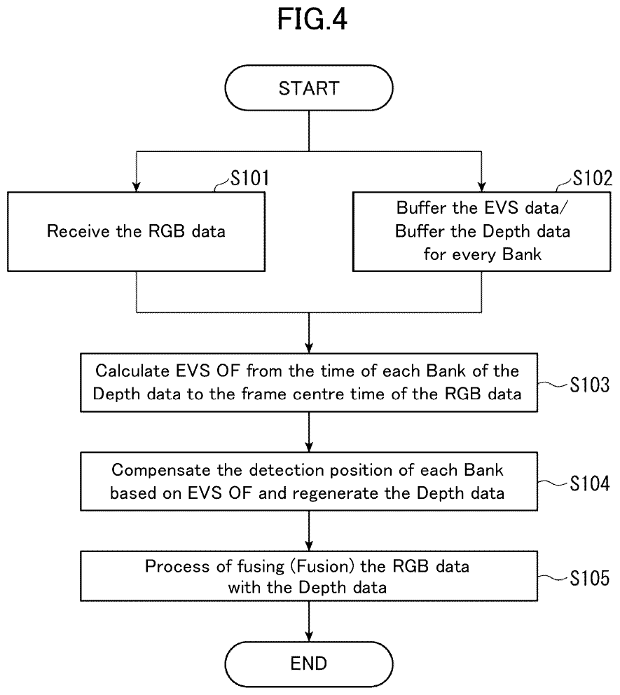

FIG. 4 is a flow chart showing an example of a process executed in an embodiment of the present disclosure. In the illustrated example, the processor 110 in the computer 100 receives RGB data imaged by the RGB camera 210 (step S101), while simultaneously buffering EVS data including the event signal acquired by the EVS 230 to the memory 120, and also buffering the Depth data acquired by the dToF sensor 220 for every Bank (step S102). Then, when the processor 110 fuses (Fusion) the RGB data with the Depth data in a frame unit, an EVS optical flow (OF) between the time of each Bank of the Depth data and a frame center time of the RGB data is initially calculated (step S103). As described above, the time resolution of the EVS 230 is higher than that of the RGB camera 210 and the dToF sensor 220, and therefore the optical flow between the center times of each frame can be generated. The processor 110 compensates a detection position of the depth in each Bank, based on the optical flow generated from the EVS data, and regenerates the Depth data (step S104). Further, the processor 110 executes a process of fusing (Fusion) the RGB data with the Depth data regenerated at step S104 (step S105).

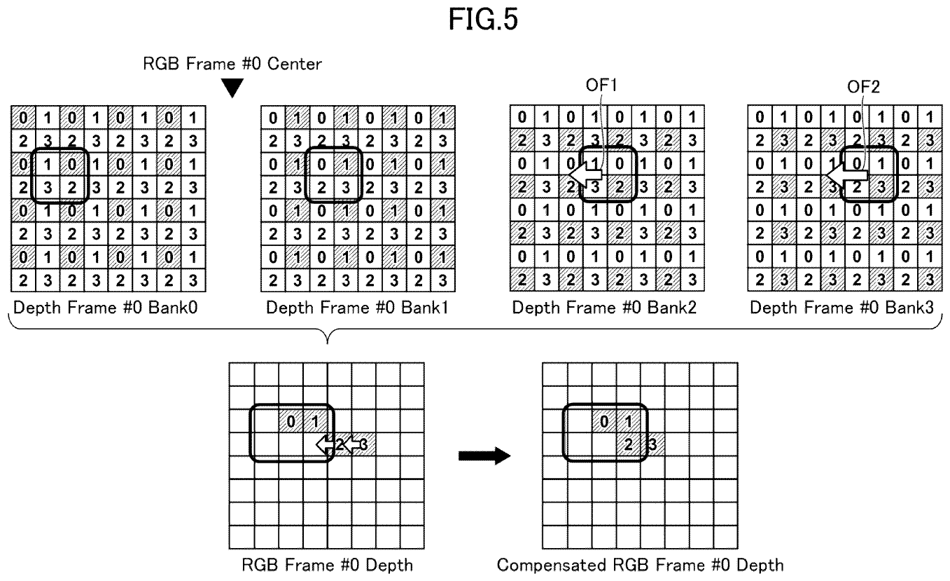

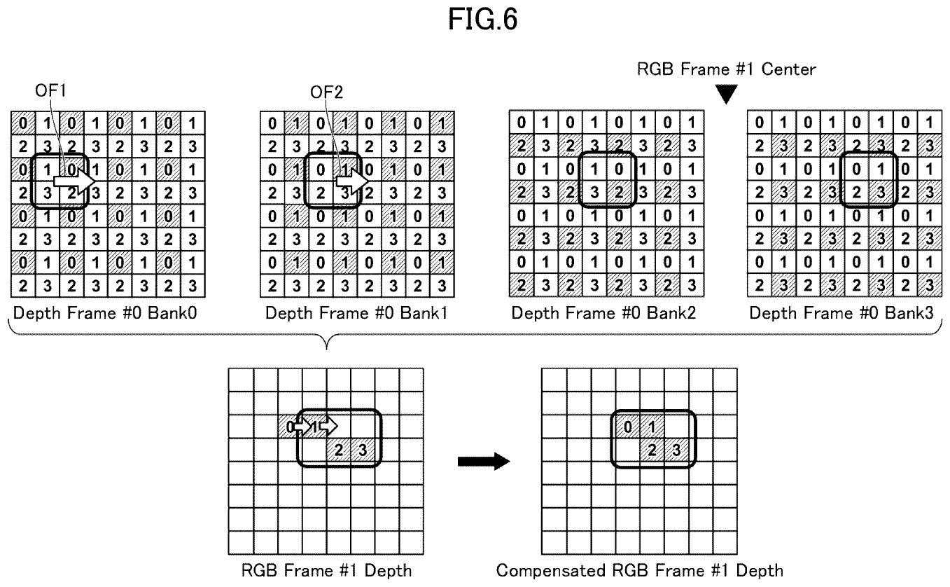

FIGS. 5 and 6 are diagrams for conceptually explaining the process in FIG. 4. FIG. 5 shows an example where the detection position of the depth associated with the RGB image of RGB Frame #0 in the example of FIG. 3 has been compensated. As explained in above step S103, in the present embodiment, the detection positions of the depth in Bank2 and Bank3 are compensated, based on the optical flows generated from the EVS data, specifically, an optical flow OF1 from the center time of Bank2 of Depth Frame #0 to the center time (Center) of RGB Frame #0, and an optical flow OF2 from the center time of Bank3 to the center time of RGB Frame #0. In accordance with this compensation, the detection positions of the depths in Bank2 and Bank3 move in a direction in which the deviation from the area in RGB Frame #0 where the subject to be photographed exists becomes smaller, so that, in RGB Frame #0 with which the compensated depth positions are associated, the deviation between the area where the subject to be photographed exists during the exposure time, and the area where the depth positions are detected is reduced in comparison with RGB Frame #0 Depth in the example of FIG. 3.

Meanwhile, FIG. 6 shows an example where the detection position of the depth associated with the RGB image of RGB Frame #1 in the example of FIG. 3 has been compensated. As in the above example of FIG. 5, the detection positions of the depths in Bank0 and Bank1 are compensated, based on the optical flow OF1 from the center time of Bank0 of Depth Frame #0 to the center time (Center) of RGB Frame #1, and the optical flow OF2 from the center time of Bank1 to the center time of RGB Frame #1. By this compensation, the detection positions of the depths in Bank0 and Bank1 are moved in a direction in which the deviation from the area in RGB Frame #1 where the subject to be photographed exists becomes smaller, so that, in RGB Frame #1 with which the compensated depth positions are associated, the deviation between the area where the subject to be photographed exists during the exposure time, and the area where the depth positions are detected is reduced in comparison with RGB Frame #1 Depth in the example of FIG. 3.

In the above examples of FIGS. 5 and 6, if the size of the optical flow exceeds a threshold value, the detection positions of the depths are compensated. For example, also in Bank0 and Bank1 in the example of FIG. 5 as well as in Bank2 and Bank3 in the example of FIG. 6, the optical flow can be generated between the center time of the Depth frame and the center time of the RGB frame. However, the size of the optical flow does not exceed the threshold value and therefore no compensation is performed. In such a case, for example, the optical flows may be generated for all the Banks to compare the sizes with the threshold value, or the optical flow need not be calculated for the Bank where a difference from the center time in the RGB frame is below the threshold value.

Next, a second embodiment of the present disclosure will be explained. In the above first embodiment, the detection position of the depth in each Bank is compensated based on the optical flows, thereby reducing the deviation between the subject to be photographed area and the depth in the RGB image. Meanwhile, in the present embodiment, a proper Bank to be associated with the RGB frame is selected over the Depth frame with the center time in the RGB frame as a criterion, thereby reducing the deviation. The examples thereof as shown in FIG. 2 are Depth Frame #-1 (one preceding frame of the Depth frame corresponding to the RGB frame) and Depth Frame #1 (the next frame of the Depth frame corresponding to the RGB frame). In the present embodiment, the optical flow is not used and therefore the EVS 230 need not be included in the system 10 shown in FIG. 1.

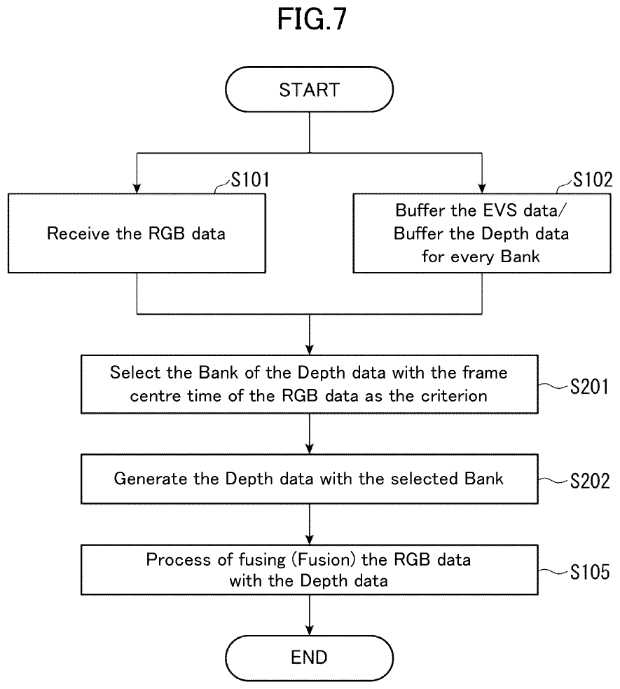

FIG. 7 is a flow chart showing the example of the process according to an embodiment of the present disclosure. Subsequent to step S101 and step S102 (where the EVS data need not be included) as in the example of FIG. 4, the processor 110 in the computer 100 selects a Bank of the Depth data with the center time in the frame of the RGB data as the criterion (step S201). At this time, as in the example described below, regardless of the relationship between the Depth frame including the Bank and the RGB frame, the Bank at the center time closer to the center time of the RGB frame is selected. Next, the Depth data are generated in the Bank selected at step S201 (step S202). Now, in the example of FIG. 2, the Depth data include each of four kinds of Banks (sub-frame data) and therefore, at step S201, even if the Depth frames are different, it is desirable to select each of the four kinds of Banks (Bank0, Bank1, Bank2, and Bank3). Further, the processor 110 executes a process of fusing (Fusion) the RGB data with the Depth data generated at step S202 (step S105).

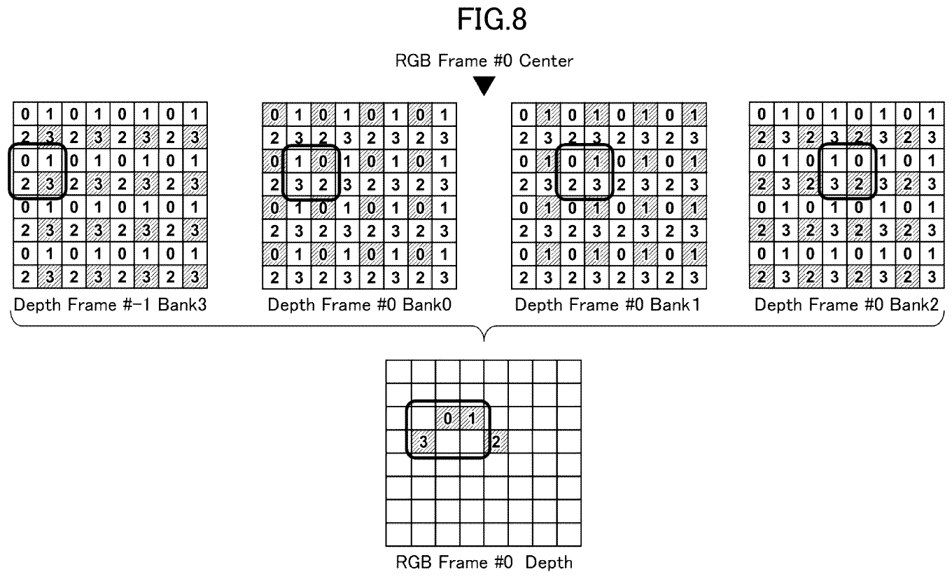

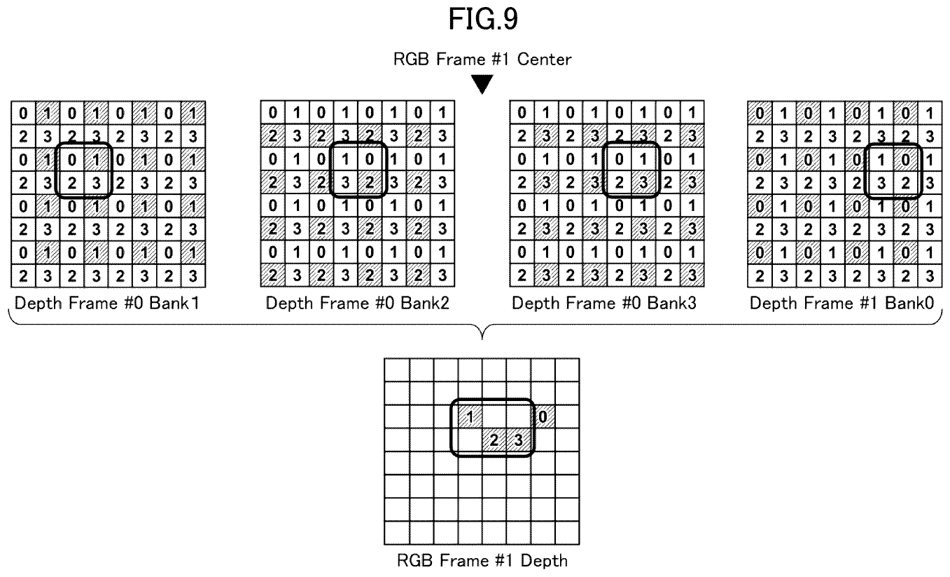

FIGS. 8 and 9 are diagrams for conceptually explaining the process in FIG. 7. FIG. 8 shows an example where the Bank associated with RGB Frame #0 in the example of FIG. 3 has been selected over the Depth frame. As explained above as step S201, in the present embodiment, regardless of the relationship between the Depth frame and the RGB frame, the Bank at the center time closer to the center time in the RGB frame is selected. In the example shown in FIG. 8, Bank3 of Depth Frame #-1 as well as Bank0, Bank1, and Bank2 of Depth Frame #0 are selected as the Banks close to the center time (Center) in RGB Frame #0. Namely, the sub-frame data of the Bank selected for generating the Depth frame include at least two sub-frame data (specifically, Bank3 of Depth Frame #-1 and Bank0 of Depth Frame #0) respectively included in different frames. More specifically, the center time of RGB Frame #0 comes before the center time of Depth Frame #0 and therefore Bank3 of Depth Frame #-1 included in one preceding Depth Frame #-1 is selected. In accordance with the above selection, the Depth data associated with RGB Frame #0 are to include Bank3 of one preceding Depth Frame #-1 in place of Bank3 of Depth Frame #0 farthest from the center time of RGB Frame #0 in the example shown in FIG. 3. The center time of Bank3 of Depth Frame #-1 is closer to the center time of RGB Frame #0 and therefore the deviation between the area where the subject to be photographed exists during the exposure time and the area where the depth positions are detected is reduced in RGB Frame #0 in comparison with the example of FIG. 3.

Meanwhile, FIG. 9 shows an example where the Bank associated with RGB Frame #1 in the example of FIG. 3 has been selected over the Depth frame. In the example of FIG. 9, Bank1, Bank2, and Bank3 of Depth Frame #0 as well as Bank0 of Depth Frame #1 are selected as the Bank close to the center time (Center) of RGB Frame #1. In this example as well, the sub-frame data of the Bank selected for the Depth frame include at least two sub-frame data (specifically, Bank3 of Depth Frame #0 and Bank0 of Depth Frame #1) respectively included in different frames. More specifically, the center time of RGB Frame #1 comes after the center time of Depth Frame #0, and therefore Bank0 of Depth Frame #1 included in the next Depth Frame #1 is selected. In accordance with the above selection, the Depth data associated with RGB Frame #1 are to include Bank0 of the next Depth Frame #1 in place of Bank0 of Depth Frame #0 farthest from the center time of RGB Frame #1 in the example shown in FIG. 3. The center time of Bank0 of Depth Frame #1 is closer to the center time of RGB Frame #1 and therefore the deviation between the area where the subject to be photographed exists during the exposure time and the area where the depth positions are detected is reduced in RGB Frame #1 in comparison with the example of FIG. 3.

In the present embodiment, as in the above examples of FIGS. 8 and 9, different combinations of Banks may be selected for successive two of the RGB frame data (RGB Frame #0 and RGB Frame #1). As a result of selecting with the center time of the RGB frame as the criterion, sometimes the Banks all included in the same Depth frame may be selected, and other times the same combination of Banks for successive two of the RGB frame data may be selected.

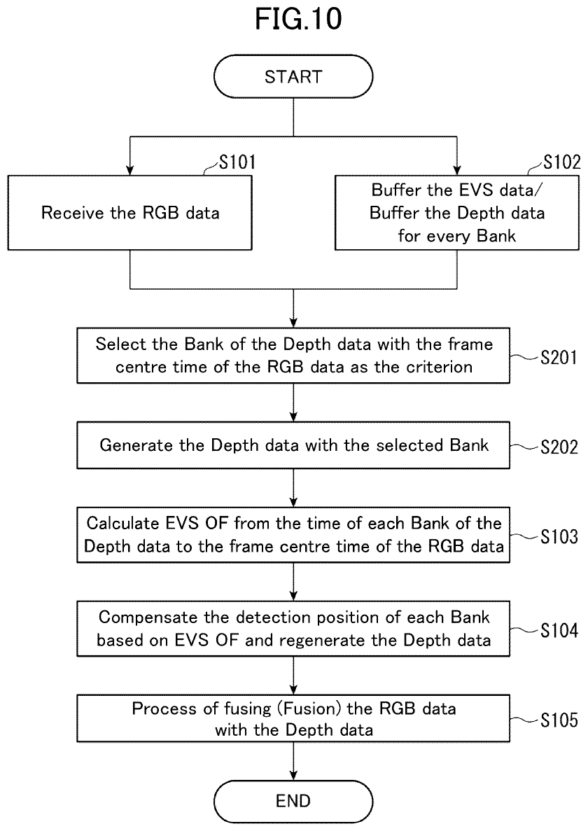

FIG. 10 is a flow chart showing the example of the process according to an embodiment of the present disclosure. The present embodiment will be explained as an embodiment obtained by combining the above first embodiment with the above second embodiment. As in the example of FIG. 7, the processor 110 in the computer 100 executes step S101, step S102, step S201, and step S202 to generate the Depth data from the Bank at the center time closer to the center time of the RGB frame. Further, the processor 110 executes step S103 and step S104 as in the example of FIG. 4, compensates the detection position of the depth, based on the EVS optical flow (OF) from the time of each Bank of the Depth data to the frame center time of the RGB data, and regenerates the Depth data. Besides, the processor 110 executes the process of fusing (Fusion) the RGB data with the Depth data regenerated at step S104 (step S105).

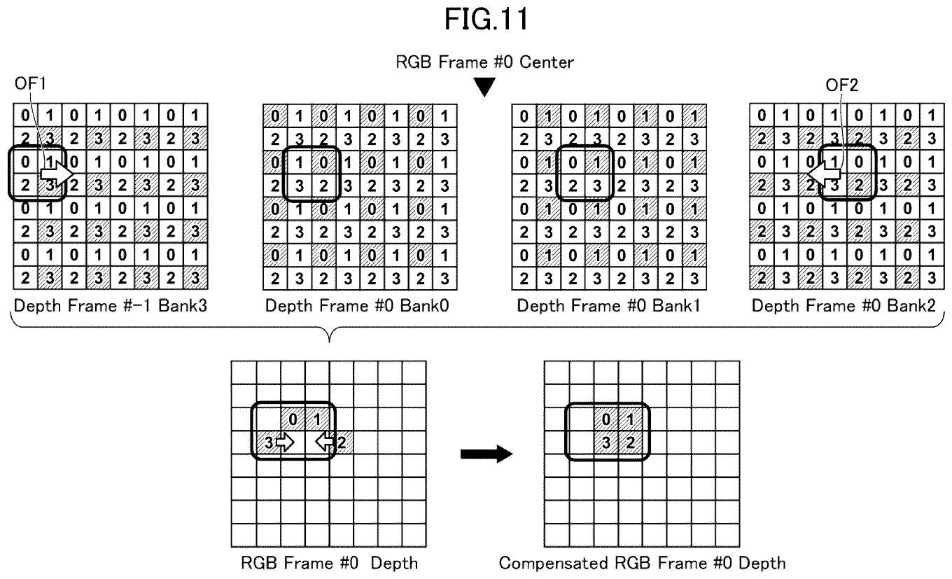

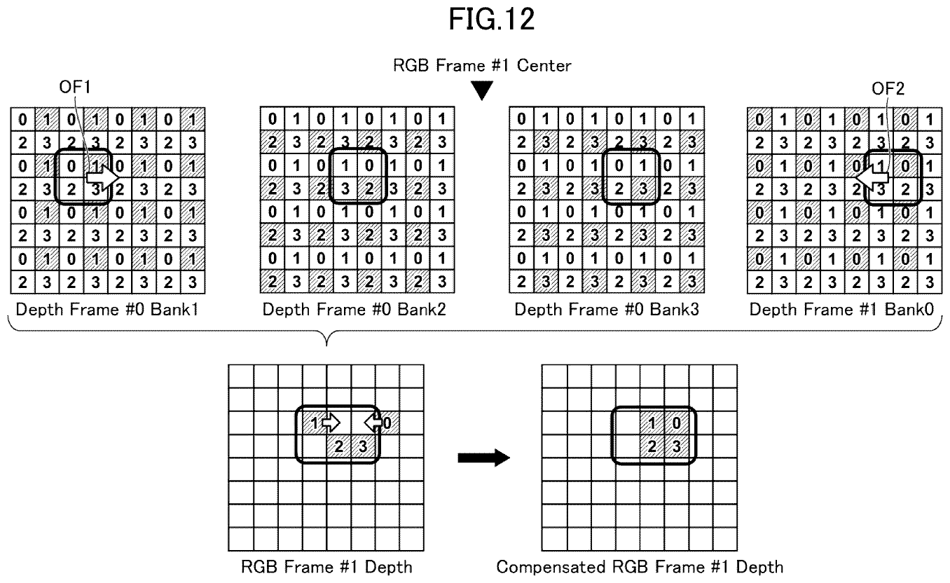

FIGS. 11 and 12 are diagrams for conceptually explaining the process in FIG. 10. FIG. 11 shows an example where the Bank associated with the RGB image of RGB Frame #0 in the example of FIG. 3 has been selected over the Depth frame and the detection position of the depth has been compensated. In the example of FIG. 11, as in the above example of FIG. 8, Bank3 of Depth Frame #-1 as well as Bank0, Bank1, and Bank2 of Depth Frame #0 are selected as the Banks close to the center time (Center) of RGB Frame #0. Further, the detection positions of the depths in each Bank are compensated, based on the optical flows generated from the EVS data, specifically, the optical flow OF1 from the center time of Bank3 of Depth Frame #-1 to the center time (Center) of RGB Frame #0, and the optical flow OF2 from the center time of Bank2 of Depth Frame #0 to the center time of RGB Frame #0. By these processes, the deviation between the area where the subject to be photographed exists during the exposure time and the area where the depth positions are detected is reduced in RGB Frame #0 with which the compensated depth positions are associated.

Meanwhile, FIG. 12 shows an example where the Bank associated with the RGB image of RGB Frame #1 in the example of FIG. 3 has been selected over the Depth frame and the detection positions of the depths have been compensated. In the example of FIG. 12, as in the above example of FIG. 9, Bank1, Bank2, and Bank3 of Depth Frame #0 as well as Bank0 of Depth Frame #1 are selected as the Banks close to the center time (Center) of GB Frame #1. Further, the detection positions of the depths in each Bank are compensated, based on the optical flows generated from the EVS data, specifically, the optical flow OF1 from the center time of Bank1 of Depth Frame #0 to the center time (Center) of RGB Frame #1, and the optical flow OF2 from the center time of Bank0 of Depth Frame #1 to the center time of RGB Frame #1. By these processes, the deviation between the area where the subject to be photographed exists during the exposure time and the area where the depth positions are detected is reduced in RGB Frame #1 with which the compensated depth positions are associated.

As has been explained above, according to the present disclosure, even if there is a difference in sampling rate between the imaging camera and the ToF sensor, the deviation between the area in the RGB frame where the subject to be photographed exists during the exposure time and the area in the Depth frame where the depth positions are detected is reduced, so that the image can be more properly associated with the distance measurement result by the ToF sensor.

FIGS. 3, 5, 6, 8, 9, 11, and 12 are schematic diagrams, hence the distance measurement point for the ToF sensor does not always correspond to the pixel of the RGB image, and the deviation between the area where the subject to be photographed exists and the area where the depth positions are detected is not recognized in a pixel unit. Further, the distance measurement points of each Bank of the ToF sensor are not always arranged in lattice and may be arranged, for example, linearly in a vertical or horizontal direction.

Further, while the RGB camera and the ToF sensor are exemplified respectively as the camera and the distance measurement sensor in the above embodiment, in another embodiment, other kinds of cameras such as an infrared camera and other kinds of distance measurement sensors such as a LiDAR may be used. In the above embodiment, the sensing result from the distance measurement sensor is associated with the image by the camera, while the embodiment of the present disclosure can be applied to any combination of the sensors (including the cameras), as far as the relationship between the frame intervals of the frames and the sub-frames is identical. In another embodiment, the images by the plurality of cameras or the detection results from the plurality of sensors may be associated with each other.

Further, in the above embodiment, the optical flow is generated from the EVS data by using the EVS, while the optical flow can also be generated by another camera or sensor having a time resolution higher than the camera or the sensor with which the image or the detection result is associated. For example, the optical flow may be generated by using a high frame rate camera in place of the EVS.

Further, in the above embodiment, the center times of the exposure are exemplified as the reference times of the RGB frame and the Depth frame, while, in another embodiment, a time other than the center time of the exposure may be used as the reference time. For example, if the frame rate of the RGB frame data is increased in accordance with a process after the imaging, the reference time may be determined from the times of the start and the end of the frame for each of the RGB frame data after increasing the frame rate thereof. Further, for example, if the RGB camera acquires the RGB image by means of a rolling shutter system, the center time of the exposure may be fused, as the reference time, with the distance measurement result of the Depth frame for every line included in the RGB frame data. In these cases, the reference time at the time of fusing the RGB frame data with the distance measurement result of the Depth frame may differ from the center time of the exposure at the time of the imaging by the RGB camera.

What is claimed is:

1. A computer system comprising:
at least one processor; and
a memory storing instructions that, when executed by the at least one processor, cause the system to:
fuse first frame data generated at a first interval by a first sensor sensing a space, with second frame data including a plurality of sub-frame data generated at an interval shorter than the first interval by a second sensor sensing the space, the second frame data being generated at a second interval longer than the first interval;
select, based on a reference time of the first frame data, at least two of the sub-frame data included in the second frame data which are respectively different;
generate the second frame data from the selected sub-frame data; and
wherein the system is configured to fuse the first frame data with the second frame data by fusing the second frame data generated from the selected sub-frame data with the first frame data.

2. The computer system according to claim 1, wherein the instructions, when executed by the at least one processor, further cause the system to select different combinations of the sub-frame data for successive two of the first frame data.

3. The computer system according to claim 1, wherein
the second frame data include at least two kinds of the sub-frame data, each including a predetermined number of sub-frame data, and
wherein the instructions, when executed by the at least one processor, further cause the system to select the sub-frame data including the at least two kinds of the sub-frame data, each including the predetermined number of sub-frame data.

4. The computer system according to claim 1, wherein the instructions, when executed by the at least one processor, further cause the system to:
select at least one of the sub-frame data included in preceding one of the second frame data, if a reference time of the first frame data comes before a reference time of the second frame data.

5. The computer system according to claim 1, wherein the instructions, when executed by the at least one processor, further cause the system to:
select at least one of the sub-frame data included in next one of the second frame data, if the reference time of the first frame data comes after the reference time of the second frame data.

6. The computer system according to claim 1, wherein the first sensor is a camera and the second sensor is a distance measurement sensor.

7. The computer system according to claim 1, wherein the instructions, when executed by the at least one processor, further cause the system to:
generate an optical flow between the reference time of at least one of the sub-frame data included in the second frame data generated from the selected sub frame data, and the reference time of the first frame data, based on a result of the space sensed by a third sensor having a time resolution higher than those of the first sensor and the second sensor; and
compensate, depending on the optical flow, a position in a sensing result included in the second frame data generated from the selected sub-frame data,
wherein the system is configured to fuse the first frame data with the second frame data by fusing the second frame data having the position in the sensing result compensated with the first frame data.

8. A method comprising:
fusing first frame data generated at a first interval by a first sensor sensing a space, with second frame data including a plurality of sub-frame data generated at an interval shorter than the first interval by a second sensor sensing the space, the second frame data being generated at a second interval longer than the first interval;
selecting, based on a reference time of the first frame data, at least two of the sub-frame data included in the second frame data which are respectively different; and
generating the second frame data from the selected sub-frame data,
wherein the fusing includes fusing the second frame data generated from the selected sub-frame data with the first frame data.

9. The method of claim 8, wherein selecting the sub-frame data includes selecting different combinations of the sub-frame data for successive two of the first frame data.

10. The method of claim 8, wherein
the second frame data include at least two kinds of the sub-frame data, each including a predetermined number of sub-frame data, and
wherein selecting the sub-frame data includes selecting the sub-frame data including the at least two kinds of the sub-frame data, each including the predetermined number of sub-frame data.

11. The method of claim 8, wherein selecting the sub-frame data includes selecting at least one of the sub-frame data included in preceding one of the second frame data, if a reference time of the first frame data comes before a reference time of the second frame data.

12. The method of claim 8, wherein selecting the sub-frame data includes selecting at least one of the sub-frame data included in next one of the second frame data, if the reference time of the first frame data comes after the reference time of the second frame data.

13. The method of claim 8, wherein the first sensor is a camera and the second sensor is a distance measurement sensor.

14. The method of claim 8, further comprising:
generating an optical flow between the reference time of at least one of the sub-frame data included in the second frame data generated from the selected sub frame data, and the reference time of the first frame data, based on a result of the space sensed by a third sensor having a time resolution higher than those of the first sensor and the second sensor; and
compensating, depending on the optical flow, a position in a sensing result included in the second frame data generated from the selected sub-frame data,
wherein the fusing includes fusing the second frame data having the position in the sensing result compensated with the first frame data.

15. A non-transitory computer-readable medium storing computer-readable instructions that, when executed by a computer, cause the computer to perform operations comprising:
fusing first frame data generated at a first interval by a first sensor sensing a space and second frame data including a plurality of sub-frame data generated at an interval shorter than the first interval by a second sensor sensing the space, and generated at a second interval longer than the first interval;
selecting, based on a reference time of the first frame data, at least two of the sub-frame data included in the second frame data which are respectively different; and
generating the second frame data from the selected sub-frame data,
wherein the fusing includes fusing the second frame data generated from the selected sub-frame data with the first frame data.

16. The non-transitory computer-readable medium of claim 15, wherein selecting the sub-frame data includes selecting different combinations of the sub-frame data for successive two of the first frame data.

17. The non-transitory computer-readable medium of claim 15, wherein
the second frame data include at least two kinds of the sub-frame data, each including a predetermined number of sub-frame data, and
wherein selecting the sub-frame data includes selecting the sub-frame data including the at least two kinds of the sub-frame data, each including the predetermined number of sub-frame data.

18. The non-transitory computer-readable medium of claim 15, wherein selecting the sub-frame data includes:
selecting at least one of the sub-frame data included in preceding one of the second frame data, if a reference time of the first frame data comes before a reference time of the second frame data; and
selecting the sub-frame data includes selecting at least one of the sub-frame data included in next one of the second frame data, if the reference time of the first frame data comes after the reference time of the second frame data.

19. The non-transitory computer-readable medium of claim 15, wherein the first sensor is a camera and the second sensor is a distance measurement sensor.

20. The non-transitory computer-readable medium of claim 15, wherein the operations further comprising:
generating an optical flow between the reference time of at least one of the sub-frame data included in the second frame data generated from the selected sub frame data, and the reference time of the first frame data, based on a result of the space sensed by a third sensor having a time resolution higher than those of the first sensor and the second sensor; and
compensating, depending on the optical flow, a position in a sensing result included in the second frame data generated from the selected sub-frame data,
wherein the fusing includes fusing the second frame data having the position in the sensing result compensated with the first frame data.
